(19) United States
(12) Patent Application Publication
(10) Pub. No.: US 2017/0238675 A1
(43) Pub. Date: Aug. 24, 2017

(54) CREAM TYPE COSMETIC CONTAINER

(71) Applicant: YONWOO CO., LTD., Incheon (KR)

(72) Inventors: Shin-Bok Jung, Incheon (KR); Hak-Chan Kim, Incheon (KR)

(73) Assignee: YONWOO CO., LTD., Incheon (KR)

(21) Appl. No.: 15/128,764

(22) PCT Filed: Mar. 23, 2015
(86) PCT No.: PCT/KR2015/002821

§ 371 Date: Sep. 23, 2016

(30) Foreign Application Priority Data
Mar. 24, 2014 (KR) 10-2014-0033807

(51) Int. Cl. A45D 40/00; B05B 11/00

(52) U.S. Cl. CPC A45D 40/0075; B05B 11/0048; B05B 11/007; B05B 11/0072; B05B 11/3032

(57) ABSTRACT

Provided is a cream-type cosmetic container having a vacuum pump which is configured such that a pumping member performs a pumping operation to discharge contents when a handle part is rotated by a predetermined section. Thus, contents having high viscosity can be discharged even with a small force. Furthermore, the container is configured such that a discharged amount of contents is adjusted according to a rotation angle of the handle part. Therefore, a user can use the container while adjusting discharged amount to a desired amount.

### BACKGROUND OF THE INVENTION

The present invention disclosed herein relates to a cream type cosmetic container. The container is configured in such a manner that when a user presses an elastic button, the elastic button moves downwards and is restored due to elasticity of the elastic button per se, and contents are discharged by changing the pressure of the inside of a container body, whereby it is possible to readily discharge contents having high viscosity through a simple structure even if a separate pumping member does not exist, and thus, not only an assembly time but also a manufacturing cost can be reduced.

Generally, cream-type cosmetic containers storing highly viscous cream are configured to interrupt a contact between air and contents contained in the cosmetic containers. Such an exemplary vacuum-type cosmetic container as above is disclosed in Korean Utility Model No. 20-0311503 filed and owned by the present applicant.

This utility model discloses a dispenser container including a container part (10) storing contents, and a dispenser (100) coupled to an upper end of the container part (10), wherein the dispenser (100) includes a cylinder (20) having an intake hole (22) and coupled to the upper end of the container part (10), a valve body (30) disposed at an intake hole (22) of the cylinder (20), a button (40) disposed at the cylinder (20) so as to perform repetitive pumping and including a tray part (42) extended so as to cover an upper part of the container part (10) at an upper end thereof, and a piston (50) disposed between an inner wall surface of the cylinder (20) and a lower end portion of the button (40). Here, the button (40) has a slide hole (44) formed at a central portion thereof in a vertical direction, and the valve body (30) has an upper end thereof upwardly extending and slidably inserted into the slide hole (44) of the button. Also, a cover member (60) is coupled to the upper end of the valve body (30) to cover the slide hole (44) of the button (40). Thus, when the button (40) is pushed, the button (40) descends along an outer circumferential surface of the valve body (30), generating a gap between the cover member (60) and the button (40), and thereby contents are discharged through the gap and collected in the tray part (42) of the button (40).

However, in this utility model, the dispenser (100) including the cylinder (20) with the intake hole (22) at the lower end thereof is coupled to an upper portion of the container part (10) to discharge contents stored in the container part (10). Accordingly, since this utility model has a structure in which pumping is performed through the dispenser (100) having a complicated structure, there is a limitation wherein an assembling time for installing the dispenser (100) increases and so does a manufacturing cost.

### SUMMARY OF THE INVENTION

The present invention is devised to solve the said problems above, and its goal is to provide a cream-type cosmetic container, which can easily discharge a highly viscous contents without a separate pumping member by allowing a button part to move downwards and then return to an original location and thus changing the internal pressure of the container body when a user pressurizes the button part, and thus can save an assembling time and reduce a manufacturing cost thereof.

Furthermore, the present invention also provides a cream-type cosmetic container, wherein by coupling a valve member made of elastic material at a bottom surface, when an elastic button descends, the valve member closes a content inflow hole and the contents stored in a content suctioning part is discharged to a content discharging hole; meanwhile, when the elastic button ascends, the valve member opens the content inflow hole and the contents stored in the container body flow into the content suctioning part with a constant amount. Therefore, the present invention is able to discharge a constant amount contents by means of a simple structure above.

The present invention is devised to solve such problems described in the above, and a cream-type cosmetic container comprises a container body receiving contents and having a volume thereof reduced according to using contents; a pumping guide cap coupled to an upper portion of the container body and having elastic deformation according to the presence/absence of a user's pressurization, thereby discharging contents contained in the container body by a pumping operation; and a content suctioning part coupled at an inner side of the container body and forming a space in which contents is stored at a lower portion of the pumping guide cap, further comprising a content inflow hole such that contents stored in the container body can move in by the constant amount.

To solve the above problems, it is featured that at a side of an upper portion of the pumping guide member is provided an elastic button made of elastic material which moves downwards and induce a pumping operation by changing the pressure of a space formed by the pumping guide cap and the content suctioning part, wherein at a bottom surface of the elastic button is provided a first valve member which opens/closes the content inflow hole.

Furthermore, it is featured that the first valve member is made of elastic material deformed when contacting an upper portion of the content suctioning part, such that the first valve member may not be interrupted by the top of the content suctioning part when the elastic button is lowered.

Furthermore, it is featured that the first valve member is molded as an integral by double injection at a bottom surface of the elastic button.

Furthermore, it is featured that the pumping guide cap further comprises a coupling part which is coupled to an upper portion of the container body and couples the pumping guide cap to the container body, and a content discharging hole which is disposed at the other side of the upper portion of the pumping guide cap and discharges contents by manipulating the elastic button.

Furthermore, it is featured that at the pumping guide cap is provided a second valve member which opens/closes the content discharging hole according to the presence or absence of pressurization.

As described above, according to the present invention, when a user presses an elastic button, the elastic button moves downwards and is restored due to elasticity of the elastic button per se, thereby changing the inside pressure of the container and discharging contents. Therefore, highly viscous contents can easily be discharged without a separate pumping member and thus not only an assembling time but also a manufacturing cost thereof is reduced.

Furthermore, since a bottom surface of the elastic button is coupled with a valve member of elastic material, when the elastic button is lowered, the valve member closes a content inflow hole and allows contents stored in the content suctioning part to a content discharging hole. Meanwhile, when the elastic button is ascended, the valve member opens the content inflow hole and leads contents stored in the container body to the content suctioning part through the content inflow hole. Therefore, the present invention has advantages in that a constant amount of contents are always discharged by means of a simple structure therein.

### BRIEF DESCRIPTION OF THE DRAWINGS

FIG. 1 is an exploded perspective view illustrating a configuration of a cream-type cosmetic container according to an exemplary embodiment of the present invention;

FIG. 2 is an assembled perspective view illustrating a configuration of a cream-type cosmetic container according to an exemplary embodiment of the present invention;

FIG. 3 is an assembled cross-sectional view illustrating a configuration of a cream-type cosmetic container according to an exemplary embodiment of the present invention; and

FIG. 4 is a view illustrating an operational state of a cream-type cosmetic container according to an exemplary embodiment of the present invention.

### DETAILED DESCRIPTION OF PREFERRED EMBODIMENTS

Hereinafter, exemplary embodiments of the present invention will be described in detail with reference to the accompanying drawings. The same reference numerals provided in the drawings indicate the same members.

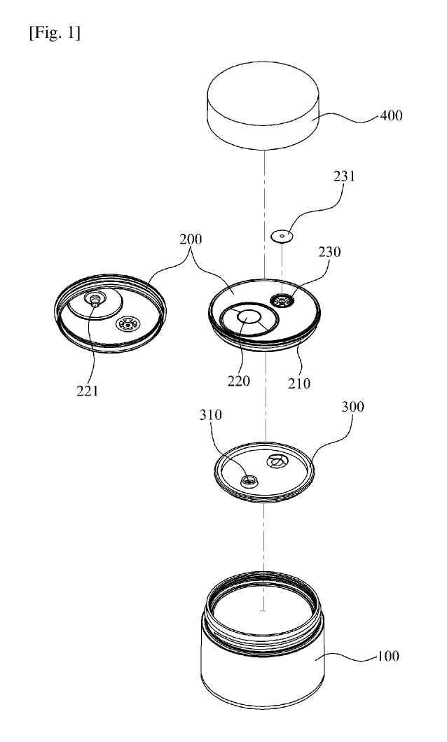

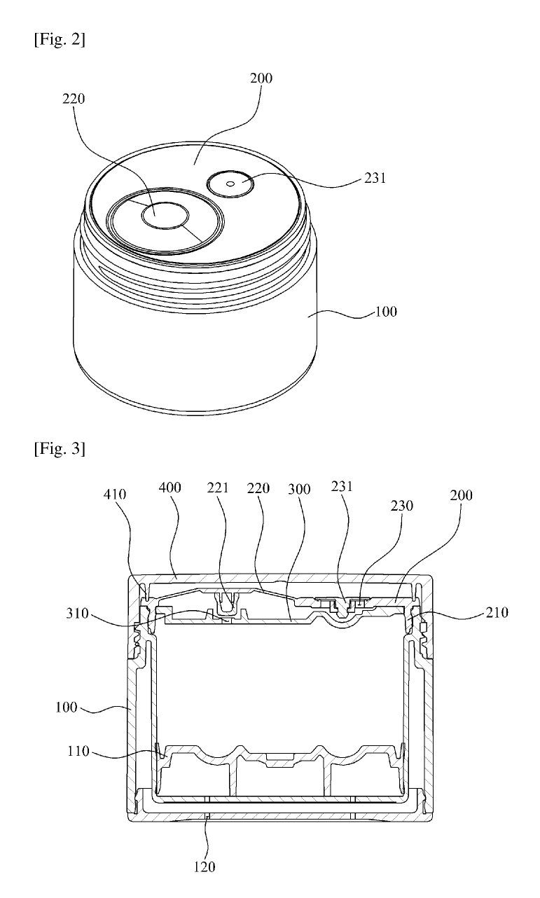

FIG. 1 is an exploded perspective view illustrating a configuration of a cream-type cosmetic container according to an exemplary embodiment of the present invention. FIG. 2 is an assembled perspective view illustrating a configuration of a cream-type cosmetic container according to an exemplary embodiment of the present invention. FIG. 3 is an assembled cross-sectional view illustrating a configuration of a cream-type cosmetic container according to an exemplary embodiment of the present invention.

Referring to FIGS. 1 to 3, a cream-type cosmetic container according to an exemplary embodiment of the present invention may include a container body 100, a pumping guide cap 200, a content suctioning part 300, and a closing cap 400.

The container body 100 receives contents and has a volume thereof reduced according to using contents. More simply saying, it is possible to install a piston 110 therein which ascends according to using contents, and also possible separately to install an inner container therein which is made of soft material and can be absorbed according to using contents.

Meanwhile, an air inflow hole 120, which will be described later, is formed at a lower end portion of the container body 100 such that air can flow into the container body 100 when the piston 110 is ascended by a pumping operation through manipulating a pumping guide cap 200.

The pumping guide cap 200 coupled to an upper portion of the container body 100 to close an upper-end opening of the container body 100 comprises a coupling part 210 coupled to an upper portion of the container body 100 so as to fix the pumping guide cap 200 to the upper portion of the container body 100.

In the present invention, at one side of the upper end of the pumping guide cap 200 is provided an elastic button 220 which is elastically deformed according to a user's pressurizing and changes the pressure of a space formed by the content suctioning part 300 which will be described later and the pumping guide cap 200, thereby discharging contents suctioned into the content suctioning part 300 to the outside. The elastic button 220 protrudes from the pumping guide cap 200 to an upward direction, and the entire surface thereof, when a user pressurizes an upper end of the elastic button 220, moves to a downward direction and then is restored when the user depressurizes, thereby changing the pressure of a space formed by the content suctioning part 300 and the pumping guide cap 200 and guiding a pumping operation. The elastic button 220 is made of elastic material so as to be deformed according to the presence or absence of a user's pressurizing.

In the present invention, at a bottom surface of the elastic button 220 is provided a first valve member 221 which opens/closes a content inflow hole 310 of the content suctioning part 300 according to the presence or absence of a user's pressurizing, wherein the first valve member 221, when the elastic button 220 descends, closes the content inflow hole 310, such that contents stored in the content suctioning part 300 can be discharged to a content discharging hole 230. Meanwhile, the first valve member 221, when the elastic button 220 ascends, opens the content inflow hole 310, such that contents stored in the container body 100 flows into the content suctioning part 300 through the content inflow hole 310 by a predetermined amount of contents.

The first valve member 221 is contacted to an upper end of the content suctioning part 300 in a process that the elastic button 220 descends and closes the content inflow hole 310; therefore, it is preferred that the first valve member 221 should be made of elastic material which can be deformed upon contacting an upper end of the content suctioning part 300 such that the elastic button 220 may not be interrupted while descending.

Furthermore, it is possible that the first valve member 221 can be fitted with a bottom surface, but it is preferable to be molded as an integral through a double injection.

Meanwhile, at the other side of the upper end of the pumping guide cap 200 is provided a content discharging hole 230 such that contents can be discharged by a pumping operation according to the manipulation of the button part 220, wherein the pumping guide cap 200 includes a second valve member 231 which opens/closes the content discharging hole 230 according to whether or not the button part 220 is pressurized.

The content suctioning part 300 is coupled to a lower portion of the pumping guide cap 200 inside the container body 100, and suctions a fixed amount of contents stored in the container body 100 due to an elastic deformation of the button part 220 of the pumping guide cap 200, forming a space for storing contents and coupled at a lower portion of the pumping guide cap 200 with a fixed distance apart such that the contents stored in the container body 100 can be absorbed and flow in the space therein.

Furthermore, a content inflow hole 310 is equipped at the content suctioning part 300 such that contents stored in the container body 100 may flow in, wherein the content inflow hole 310 is preferred to be disposed at directly below a first valve member 221 so as to be opened/closed by the first valve member 221 equipped at the bottom surface of the elastic button 220 according to whether the elastic button 220 is pressurized or not.

The content suctioning part 300 may suction and store a uniform amount of contents contained in the container body 100, and may be guided so as to discharge a uniform amount of contents upon pumping operation according to the manipulation of the button part 220.

The closing cap 400 coupled to an upper portion of the container body 100 while covering the pumping guide cap 200 prevents a malfunction of the button part 220, and also prevents the first valve member 221 from being destroyed by an external impact.

At an upper end of the closing cap 400 is formed a pressurizing protrusion 410 pressurizing an upper end of the pumping guide cap 200 such that the pumping guide cap 200 can be prevented from being separated from the container body 100.

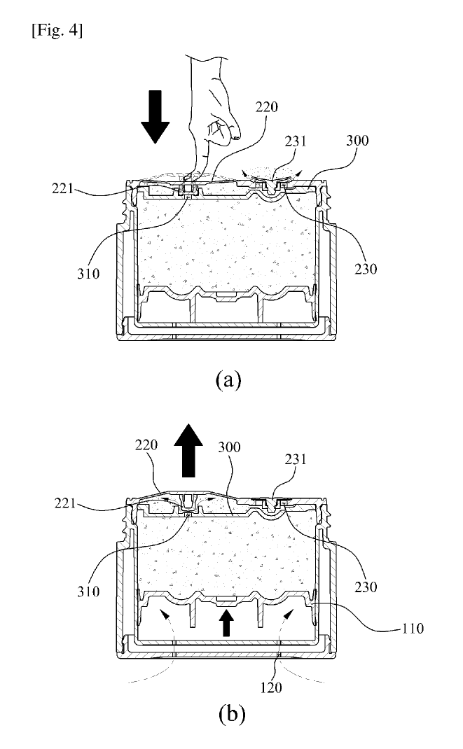

Hereinafter, referring FIG. 4, an operational state of a cream-type cosmetic container according to an exemplary embodiment of the present invention will be described. FIG. 4 is a view illustrating an operational state of a cream-type cosmetic container according to an exemplary embodiment of the present invention.

Referring FIG. 4, in a cream-type cosmetic container according to an exemplary embodiment of the present invention, when a user pressurizes an elastic button 220 formed at a side of the pumping guide cap 200, the elastic button 220 made of elastic material moves downwards, and thereby moves along with a first valve member 221 equipped at a bottom surface of the elastic button 220, thus closing a content inflow hole 310.

In a process of the elastic button 220's descending as the above, when the first valve member 221 closes the content inflow hole 310, the contents stored in a space formed by the pumping guide cap 200 and the content suctioning part 300 move to a direction of content discharging hole 230 formed at the other side of the pumping guide cap 200, and the first valve member 221 closed by the content discharging hole 230 opens the content discharging hole 230 by the content pressure, thereby discharging the contents absorbed into the content suctioning part 300 to an top surface of the pumping guide cap 200.

Meanwhile, when a user releases a pressurization of an elastic button 220, the elastic button 220 is restored by an inherent elasticity of the elastic button 220 and moves upwards, and thereby a first valve member 221 equipped at a bottom surface of the elastic button 220 ascends along and opens the content inflow hole 310.

In a process of the elastic button 220's ascending as the above, when the first valve member 221 opens the content inflow hole 310, a fixed amount of the contents stored in a space formed by the pumping guide cap 200 and the content suctioning part 300, which can be discharged during the next pumping operation, move into the content suctioning part 300 through the content inflow hole 310. At this time, a second valve member 231 closes the content discharging hole 230.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Therefore, those skilled in the art will appreciate that various modifications and other equivalent embodiments are possible from the above embodiments. Therefore, the scope of the present invention should be defined by the technical spirit of the accompanying claims.

What is claimed is:

1. A cream-type cosmetic container having a vacuum pump comprising:
a container body (100) containing contents and having a volume thereof reduced according to using contents;
a pumping guide cap (200) coupled at an upper portion of the container body (100) and elastically deformed according to the presence/absence of a user's pressurization, thereby discharging contents contained in the container body (100); and
a content suctioning part (300) coupled at an inner side of the container body (100) and forming a space for storing contents at a lower portion of the pumping guide cap (200), further comprising a content inflow hole (310) such that contents contained in the container body (100) can flow in with a constant amount by an elastic deformation of the pumping guide cap (200),
wherein at a side of an upper portion of the pumping guide cap (200) is provided an elastic button (220) which moves downwards by own elastic force thereof according to the presence/absence of a user's pressurization and then is restored, the elastic button (220) made of elastic material and inducing a pumping operation by changing a pressure of a space formed by the pumping guide cap (200) and the content suctioning part (300),
wherein at a bottom surface of the elastic button (220) is provided a first valve member (221) which opens/closes the content inflow hole (310) according to whether an elastic button (220) is pressurized or not.

2. The cream-type cosmetic container having a vacuum pump of claim 1, wherein the first valve member (221) is made of elastic material deformed upon contacting with an upper end of the content suctioning part (300) when the elastic button (220) descends, such that the first valve member (221) can be prevented from being interfered by an upper end of the content suctioning part (300).

3. The cream-type cosmetic container having a vacuum pump of claim 2, wherein the first valve member (221) is molded as an integral through a double injection to be fitted at a bottom surface.

4. The cream-type cosmetic container having a vacuum pump 3, wherein the first valve member (221) further comprises a coupling part (210) which is coupled to an upper portion of the container body (100) and fixes the pumping guide cap (200) to the container body (100); and a content discharging hole (230) disposed at the other side of the upper portion of the pumping guide cap (200) and discharging contents by the manipulation of the button part (220).

5. The cream-type cosmetic container having a vacuum pump of claim 4, wherein a second valve member (231) is provided at the pumping guide cap (200) so as to open/close the content discharging hole (230) according to whether the elastic button (220) is pressurized or not.
